(19) United States
(12) Patent Application Publication
(10) Pub. No.: US 2025/0240225 A1
(43) Pub. Date: Jul. 24, 2025

(54) Radio Network Node, User Equipment and Methods Performed Therein

(71) Applicant: Telefonaktiebolaget LM Ericsson (publ), Stockholm (SE)

(72) Inventors: Mattias Bergström, Sollentuna (SE); Cecilia Eklöf, Täby (SE); Johan Rune, Lidingö (SE); Filip Barac, Huddinge (SE); Luca Lunardi, Genova (IT); Ali Parichehrehteroujeni, Linköping (SE)

(21) Appl. No.: 18/703,528

(22) PCT Filed: Oct. 20, 2022
(86) PCT No.: PCT/SE2022/050952

§ 371 Date: Apr. 22, 2024

Related U.S. Application Data
(60) Provisional application No. 63/262,813, filed on Oct. 21, 2021.

(51) Int. Cl. H04L 41/5067; H04W 24/10; H04W 76/20

(52) U.S. Cl. CPC H04L 41/5067; H04W 24/10; H04W 76/20

(57) ABSTRACT

Embodiments herein relate to, for example, a method performed by a user equipment, UE, (10) for handling communication in a wireless communications network. The UE (10) receives from an upper layer an indication relating to a quality of experience, QoE, process; and applies the indication in one or more messages and/or for one or more bearers. The UE (10) applies the indication by selecting a message type and/or a bearer type to send the indication to a radio network node depending on a type of a QoE measurement and/or a criticality of the QoE measurement of the indication.

### TECHNICAL FIELD

Embodiments herein relate to a radio network node, a user equipment (UE) and methods performed therein regarding wireless communication. Furthermore, a computer program and a computer readable storage medium are also provided herein. In particular, embodiments herein relate to handling communication, such as handling or controlling quality of experience (QoE) measurements, in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

QoE measurements have been specified for LTE and UMTS and it is being specified for NR. The purpose of the application layer measurements is to measure the end user experience when using certain applications. Currently QoE measurements for streaming services and for Mobility Telephony Service for IMS (MTSI) services are supported. IMS stands for IP Multimedia Subsystem.

The solutions in LTE and UMTS are similar with the overall principles as follows. Quality of Experience Measurement Collection enables configuration of application layer measurements in the UE and transmission of QoE measurement result files by means of radio resource control (RRC) signaling. Application layer measurement configuration received from operation and maintenance (O&M) or a CN is encapsulated in a transparent container, which is forwarded to a UE in a downlink RRC message. Application layer measurements received from a UE's higher layer are encapsulated in a transparent container and sent to network in an uplink RRC message. The result container is forwarded to a Trace Collector Entity (TCE).

In 3GPP release 17 a study item for “Study on NR QoE management and optimizations for diverse services” for NR has been carried out. Purpose of the study item was to study solutions for QoE measurements in NR. QoE management in NR will not just collect the experience parameters of streaming services but also consider the typical performance requirements of diverse services, e.g., augmented reality (AR), virtual reality (VR) and ultra reliable low latency communication (URLLC).

The measurements may be initiated towards a RAN in management-based manner, i.e., from an O&M node in a generic way e.g. for a group of UEs, which may be selected by the RAN, or they may also be initiated in a signalling-based manner, i.e. initiated from a CN, on request from the O&M system, to the RAN e.g. for a single specific UE. The configuration of the measurement includes the measurement details, which is encapsulated in a container that is transparent to the RAN.

When initiated via the CN, the measurement is started towards a specific UE. For the LTE case, the “TRACE START” S1AP message is used, which carries, among others, the details about the measurement configuration the application should collect, in the “Container for application layer measurement configuration” IE, transparent to the RAN, and the details to reach the trace collection entity to which the measurements should be sent.

Notifications of started and stopped application sessions with associated QoE measurement configurations are introduced, where these notifications are conveyed from the application layer in the UE and to the UE Access Stratum, i.e., the radio layers in the UE, and then forwarded to the network. This allows the network, at least the RAN, to be aware of when QoE measurements on an application session are ongoing. It is an implementation decision when the RAN stops the measurements. Typically, it is done when the UE has moved outside the configured area for measurement, also referred to as the area scope. However, this strategy is questioned by the desire to have QoE data that represent complete application sessions.

The signalling diagram in FIG. 1 is copied from 3GPP TS 28.405 v16.0.0. It provides an overview, without showing all the details, of the signalling involved in QoE measurement configuration, from the O&M system to the UE.

The diagram is a copy of a diagram in 3GPP TS 28.405 v16.0.0 labeled “FIG. 4.2.1-1: QMC activation and reporting in LTE”.

One opportunity provided by legacy solution is also to be able to keep the QoE measurement for the whole application session, even during handover situation, so that reported QoE measurement data cover complete application sessions.

QoE measurement in E-UTRAN.

### E-UTRAN—Application Layer Measurement Capabilities

For E-UTRAN, the UE capability transfer is used to transfer UE radio access capability information from the UE to E-UTRAN, see FIG. 2a.

FIG. 2a shows UE capability transfer—E-UTRAN.

The UE-EUTRA-Capability information element (IE) is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the UE-EUTRA-Capability-v1530 IE which can be used by the UE to indicate whether the UE supports QoE Measurement Collection for streaming services and/or MTSI services or not, as detailed in the “MeasParameters-v1530” IE encoding below.

The contribution CR 4297 (R2-2004624) for 3GPP TS 36.331 v16.0.0 at the 3GPP TSG RAN2 Meeting #110 proposed an extension of the “UE-EUTRA-Capability” IE that, within the “UE-EUTRA-Capability-v16xy IE may include a “measParameters-v16xy” IE comprising the qoe-Extensions-r16 IE. The qoe-Extensions-r16 IE may be used to indicate whether the UE supports the release 16 extensions for QoE Measurement Collection, i.e., if the UE supports more than one QoE measurement type at a time and if the UE supports the signalling of withinArea, sessionRecordingIndication, qoe-Reference, temporaryStopQoE and restartQoE.

### E-UTRAN—Application Layer Measurement Reporting

The purpose of the “Application layer measurement reporting” procedure described in 3GPP TS 36.331 and shown in FIG. 2b is to inform E-UTRAN about application layer measurement report.

FIG. 2b shows Application layer measurement reporting in E-UTRAN.

A UE capable of application layer measurement reporting in RRC_CONNECTED may initiate the procedure when configured with application layer measurement, i.e., when measConfigAppLayer has been configured by E-UTRAN.

Upon initiating the procedure, the UE shall:
1> if configured with application layer measurement, and signalling radio bearer four (SRB4) is configured, and the UE has received application layer measurement report information from upper layers:
2> set the measReportAppLayerContainer in the MeasReportAppLayer message to the value of the application layer measurement report information;
2> set the serviceType in the MeasReportAppLayer message to the type of the application layer measurement report information;
2> submit the MeasReportAppLayer message to lower layers for transmission via SRB4.

### E-UTRAN—QoE Measurement Configuration Setup and Release—RRC Signaling

The RRCConnectionReconfiguration message is used to reconfigure the UE to setup or release the UE for Application Layer measurements. This is signalled in the measConfigAppLayer-15 IE within the “OtherConfig” IE.

The setup includes the transparent container measConfigAppLayerContainer which specifies the QoE measurement configuration for the Application of interest and the serviceType IE to indicate the Application (or service) for which the QoE measurements are being configured. Supported services are streaming and MTSI.

The contribution CR 4297 (R2-2004624) for 3GPP TS 36.331 v16.0.0 at the 3GPP TSG RAN2 Meeting #110 proposed to extend the QoE measurement configuration.

The measConfigAppLayerToAddModList-r16 may be used to add or modify multiple QoE measurement configurations, up to maxQoE-Measurement-r16. The measConfigAppLayerToReleaseList-r16 IE may be used to remove multiple QoE measurement configuration, up to maxQoE-Measurement-r16.

### E-UTRAN—QoE Measurement Reporting—RRC Signaling

As specified in 3GPP TS 36.331, the MeasReportAppLayer RRC message is used by the UE to send to the E-UTRAN node the QoE measurement results of an Application (or service). The service for which the report is being sent is indicated in the “serviceType” IE.

The contribution CR 4297 (R2-2004624) for 3GPP TS 36.331 v16.0.0 at the 3GPP TSG RAN2 Meeting #110 proposed to extend the MeasReportAppLayer IEs introducing a QoE reference comprising the public land mobile network (PLMN) identity and the identifier of the QoE Measurement Collection

For E-UTRAN, an example of desired UE behavior for Application layer measurement reporting is described in CR 4297 (R2-2004624):

### UE Application Layer Measurement Configuration

The “UE Application layer measurement configuration” IE is described in 3GPP TS 36.413 v16.3.0 and TS 36.423 v16.3.0.

### Area Scope for QoE Measurements

According to 3GPP TS 28.405, the area scope parameter defines the area in terms of cells or Tracking Area/Routing Area/Location Area where the QoE measurement collection (QMC) shall take place. If the parameter is not present the QMC shall be done throughout the PLMN specified in PLMN target.

The area scope parameter in UMTS is either:
List of cells, identified by cell global identifier (CGI). Maximum 32 CGI can be defined.
List of Routing Area, identified by routing area identifier (RAI). Maximum of 8 RAIs can be defined.
List of Location Area, identified by location area identifier (LAI). Maximum of 8 LAIs can be defined.

The area scope parameter in LTE is either:
list of cells, identified by E-UTRAN-CGI. Maximum 32 CGI can be defined.
List of Tracking Area, identified by tacking area code (TAC). Maximum of 8 TAC can be defined.

The parameter is mandatory if area based QMC is requested.

### SUMMARY

As part of developing embodiments herein a problem was first identified. 3GPP has standardized a QoE measurement framework for LTE and is currently specifying QoE for NR in release 17. The QoE framework for NR will include regular QoE measurement and reporting, where the O&M system originates the QoE configuration and is the final receiver of (regular) QoE reports, and wherein the RAN relays QoE configurations and QoE reports but cannot interpret any of them. In addition, 3GPP is specifying a variant referred to as RAN Visible QoE (RVQoE), which may be configured by the RAN. or possibly the O&M system, and the RAN is the receiver of RVQoE reports, where the information in the RVQoE reports are modified versions of the regular QoE metrics, or data derived for QoE metrics. The regular QoE reports are intended to be used for long-term configuration optimization, whereas RVQoE reports are intended to be used for real-time adaptations of configurations and various mechanisms, such as scheduling priorities, to ensure that appropriate QoE is maintained for an ongoing application session.

The natures of regular QoE and RVQoE are thus quite different in that regular QoE, and in particular the reported data, is inherently delay-insensitive, and is therefore transmitted on the low-priority signaling radio bearer SRB4, e.g., in the MeasReportAppLayer message in LTE, while the corresponding message for NR is not specified yet, whereas RVQoE data is supposed to have immediate impact on the RAN's actions and is thus much more delay-sensitive than regular QoE reporting. Moreover, it is also possible that, within the same QoE report type, certain individual reports or sets of reports pertaining to certain measurement configurations, are more critical than some other. For example, RVQoE reports pertaining to URLLC service type are generally more critical than RVQoE reports pertaining to the MTSI service type.

This raises the question how RVQoE reports are to be transmitted and how this relates to transmission of regular QoE reports.

An object herein is to provide a mechanism to handle QoE or measurements of QoE of a UE in an efficient manner in the wireless communications network.

According to an aspect the object is achieved, according to embodiments herein, by providing a method performed by a UE for handling communication or measurements in a wireless communications network. The UE receives from an upper layer an indication relating to a quality of experience process, and the UE applies the indication in one or more messages, also referred to as report handling, and/or to one or more bearers. That the UE applies the indication comprises that the UE selects a message type and/or a bearer type to send the indication to a radio network node depending on a type of a QoE measurement and/or a criticality of the QoE measurement of the indication. The UE may apply different QoE measurement types in different messages or in a same message.

According to another aspect the object is achieved, according to embodiments herein, by providing a method performed by a radio network node for handling communication in a wireless communications network. The radio network node configures a UE to apply one or more indications relating to a quality of experience process in one or more messages, also referred to as report handling, for one or more bearers. That the UE applies the indication comprises that the UE selects a message type and/or a bearer type to send the indication to a radio network node depending on a type of a QoE measurement and/or a criticality of the QoE measurement of the indication.

According to aspects the object is achieved, according to embodiments herein, by providing a UE and a radio network node configured to perform the methods herein, respectively.

According to yet another aspect the object is achieved, according to embodiments herein, by providing a UE for handling communication or measurements in a wireless communications network. The UE is configured to receive from an upper layer an indication relating to a quality of experience process, and the UE is configured to apply the indication in one or more messages, also referred to as report handling, and/or to one or more bearers. The UE is configured to apply the indication in that the UE is configured to select a message type and/or a bearer type to send the indication to a radio network node depending on a type of a QoE measurement and/or a criticality of the QoE measurement of the indication.

According to still another aspect the object is achieved, according to embodiments herein, by providing a radio network node for handling communication in a wireless communications network. The radio network node is adapted to configure a UE to apply one or more indications relating to a quality of experience process in one or more messages, also referred to as report handling, for one or more bearers. That the UE applies the indication comprises that the UE selects a message type and/or a bearer type to send the indication to a radio network node depending on a type of a QoE measurement and/or a criticality of the QoE measurement of the indication.

It is furthermore provided herein a computer program product comprising instructions, which, when executed on at least one processor, cause the at least one processor to carry out the methods herein, as performed by the UE or the radio network node, respectively. It is additionally provided herein a computer-readable storage medium, having stored thereon a computer program product comprising instructions which, when executed on at least one processor, cause the at least one processor to carry out any of the methods herein, as performed by the UE or the radio network node, respectively.

Embodiments herein disclose a solution that handles the indication in an efficient and structured manner. In some embodiments the UE sends different types of QoE reports, such as regular QoE reports and RVQoE reports, in different message types. In some embodiments, the UE sends different types of QoE reports in the same message type, but routes the messages on different (signal) radio bearers.

In some embodiments the UE ensures that when QoE reports or different types are to be sent, these QoE reports are sent in separate instances of messages.

In some embodiments, the UE can be reconfigured from a first configuration of (signalling) radio bearers for reporting QoE reports of different types to a second configuration of (signalling) radio bearers or reporting QoE reports of different types. A use case when this can happen is one or more of the following: upon mobility, air interface overload, upon addition or removal of QoE configuration for a service type.

Embodiments herein provide means for sending different type of QoE reports in different ways, e.g. in different messages, on different (signal) radio bearers such that depending on which type of QoE report is sent, they can be sent with a suitable priority.

In addition, routing indications such as Session start indication or Session end indication over radio bearers different from the one configured for the QoE measurement for application layer, enables the UE to use e.g., default radio bearer to indicate to the network initiation of a QoE measurements. For example, indicating a session start indication over SRB1 to the network enables the RAN node to configure SRB4 for the UE if the SRB4 is not configured e.g., when UE comes to the RRC connected mode from the RRC IDLE mode. Hence, the UE would be able to notify the presence of the QoE measurement reports and network can take appropriate actions, e.g., configuring the UE with SRB4, for delivery of the QoE reports.

Thus, using one or more indications related to QoE measurements as in embodiments herein QoE or measurements of QoE of a UE are handled efficiently in the wireless communications network.

### BRIEF DESCRIPTION OF THE DRAWINGS

Embodiments will now be described in more detail in relation to the enclosed drawings, in which:

FIG. 1 shows a signalling scheme according to prior art;

FIG. 2a-2b shows signalling schemes according to prior art;

FIG. 3 shows an overview depicting a wireless communications network according to embodiments herein;

FIG. 4 shows a flowchart depicting a method performed by a UE according to embodiments herein;

FIG. 5 shows a flowchart depicting a method performed by a radio network node according to embodiments herein;

FIG. 6 shows a block diagram depicting embodiments of a UE according to embodiments herein;

FIG. 7 shows a block diagram depicting embodiments of a radio network node according to embodiments herein;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10, 11, 12, and 13 are flowcharts illustrating methods implemented in a communication system including a host computer, a base station and a user equipment.

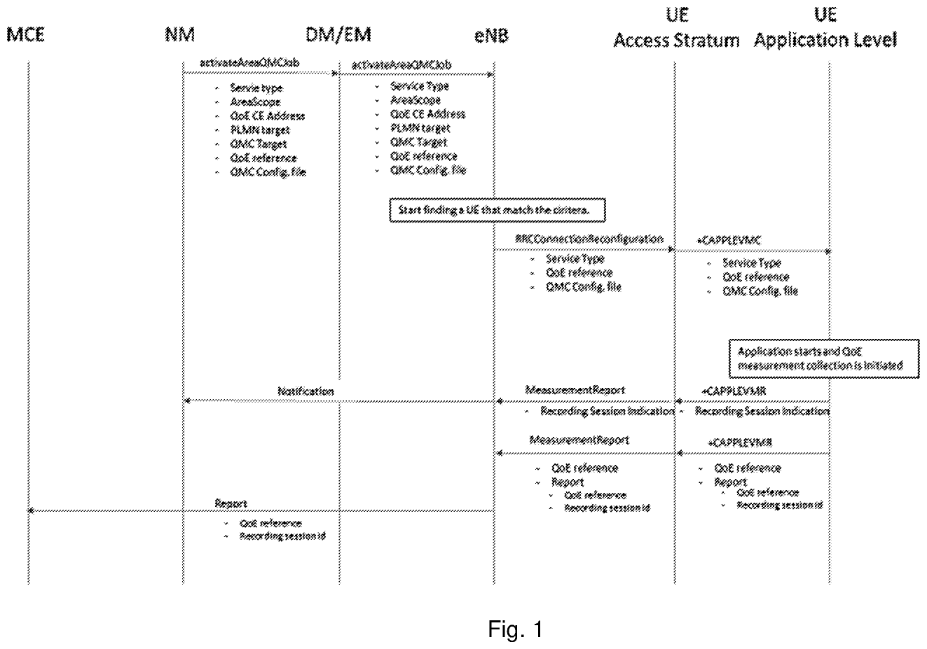

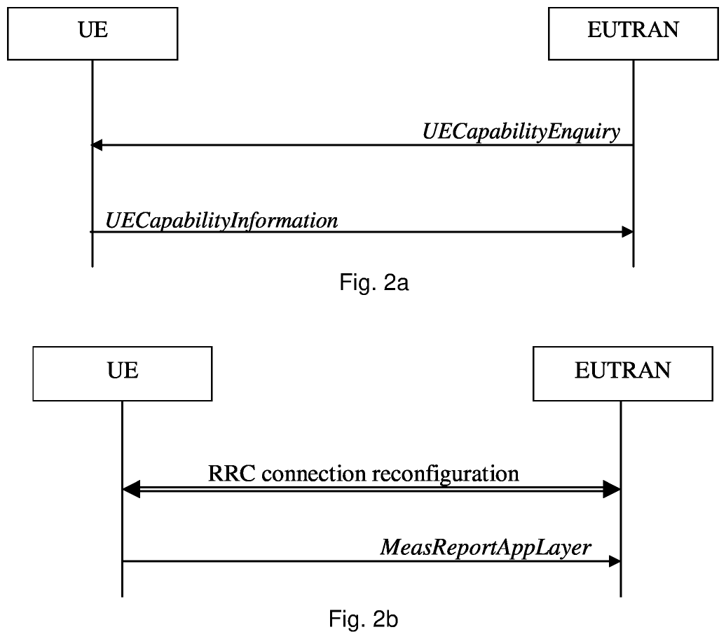

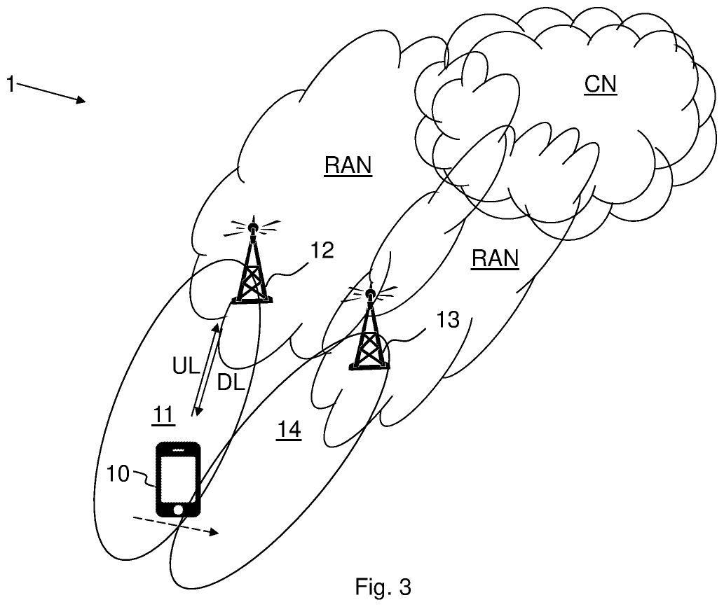

### DETAILED DESCRIPTION

Embodiments herein relate to wireless communications networks in general. FIG. 3 is a schematic overview depicting a wireless communications network 1. The wireless communications network 1 comprises one or more RANs and one or more CNs. The wireless communications network 1 may use one or a number of different technologies.

Embodiments herein relate to recent technology trends that are of particular interest in a NR context, however, embodiments are also applicable in further development of existing wireless communications systems such as e.g. LTE or WCDMA.

In the wireless communications network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. RAN, to one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12, also referred to as the radio network node, providing radio coverage over a geographical area, a first service area 11 or first cell, of a first radio access technology (RAT), such as NR, LTE, or similar. The first radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the first radio network node 12 depending e.g. on the first radio access technology and terminology used. The first radio network node 12 may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage.

The wireless communications network 1 comprises a second radio network node 13 providing radio coverage over a geographical area, a second service area 14 or second cell, of a second RAT, such as NR, LTE, or similar. The second radio network node 13 may be a transmission and reception point such as an access node, an access controller, a base station, e.g. a radio base station such as a gNodeB (gNB), an eNB, eNode B), a NodeB, a base transceiver station, a radio remote unit, an Access Point Base Station, a base station router, a WLAN access point or an AP STA, a transmission arrangement of a radio base station, a stand-alone access point or any other network unit or node capable of communicating with a wireless device within the area served by the radio network node depending e.g. on the second radio access technology and terminology used. The second radio network node 13 may be referred to as a second PLMN radio network node wherein the service area may be referred to as a second PLMN cell.

According to embodiments herein the UE 10 receives from an upper layer an indication relating to a QoE process. The UE 10 processes or applies the indication in a message, wherein the UE selects a message type and/or a bearer type to send the indication to a radio network node, such as the first radio network node 12, depending on a type of a QoE measurement and/or a criticality of the QoE measurement of the indication. The UE 10 may then transmit the message to a lower layer.

Embodiments herein discuss different types of QoE measurements/reports and indications, namely:
a regular QoE measurement, i.e., QoE measurements for application layer, which herein may refer to measurements of QoE that is performed by the UE which are intended to be consumed in a node above the RAN. I.e. that the intended recipient of these measurements is a node above the RAN, for example an application layer server. This type of QoE is referred to as regular QoE (or just QoE).
a RAN visible QoE measurement, i.e., QoE measurements for RAN, which herein may refer to measurements of QoE that is performed by the UE which are intended to be consumed in the RAN. I.e. that the intended recipient of these measurements is a RAN node. This type of QoE is referred to as RAN Visible QoE (RVQoE).
Session Start Indication will herein refer to an indication received from the upper layer, indicating start of a session at the upper layer (e.g., application).
Session End Indication will herein refer to an indication received from the upper layer, indicating end of a session at the upper layer (e.g., application).

Furthermore, regarding criticality an RVQoE report pertaining to URLLC service type may for example be more critical than RVQoE reports pertaining to an MTSI service type. Thus, criticality may be based on type of service.

It should be noted that while this document discusses examples with the above different types of reports/indications, the methods described herein may be generalized and applied also for other types of reports/indications.

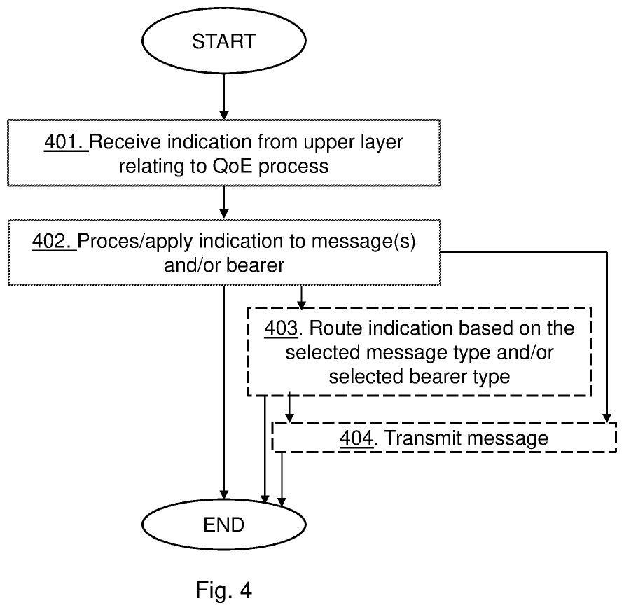

The method actions performed by the UE 10 for handling communication in the wireless communications network 1 according to embodiments herein will now be described with reference to a flowchart depicted in FIG. 4. The actions do not have to be taken in the order stated below, but may be taken in any suitable order. Actions performed in some embodiments are marked with dashed boxes.

Action 401. The UE 10 receives from an upper layer an indication relating to a QoE process. The indication may comprise one or more of the following: a regular QoE measurement, a RAN visible QoE measurement, a Session Start Indication, and a Session End Indication. Thus, the UE 10 may receive the indication from the upper layer (e.g., application layer), the indication may be at least
a regular QoE measurement such as a QoE measurements for application layer, or
a RAN visible QoE measurement such as a QoE measurements for RAN, or
Session Start Indication, or
Session Stop/End indication.

Action 402. The UE 10 processes or applies the indication in one or more messages, also referred to as report handling, and/or for one or more bearers, wherein applying the indication comprises that the UE 10 selects a message type and/or a bearer type to send the indication to a radio network node, such as the first radio network node 12 or the second radio network node 13, depending on a type of a QoE measurement and/or a criticality of the QoE measurement of the indication. Different message types may comprise a MeasReportAppLayer message, a MeasurementReport, or a UEAssistancelnfo message. The UE 10 may apply different QoE measurement types in different messages. In one embodiment the UE 10 may send QoE measurements in different messages depending on the type of QoE measurement. If the QoE measurement is of a first type, the UE 10 may send the measurement in a first message, but if the QoE measurement is of a second type, the UE 10 may send the measurement in a second message.

For example, the UE 10 may send QoE measurements for application layer in a message MeasReportAppLayer (which is the present specification for LTE and which may be specified for NR too). But it sends QoE measurements for RAN in another message.

The other message may be for example be one of the following:
A MeasurementReport
A UEAssistancelnfo
A UEInformationResponse
A message defined for the purpose of sending QoE measurements for RAN, such as a message over SRB1.

The selection of message type to carry a certain type of QoE report may be determined on the UE Application layer, while in another related embodiment it is executed at the UE Access Stratum (AS) layer.

Action 403. The UE 10 may route the indication to the radio network node based on the selected message type and/or selected bearer type.

The UE 10 may route the first message on a first bearer, and the second message on a second bearer. For example, the MeasReportAppLayer may be sent on SRB4, while the MeasurementReport may be sent on SRB1 or SRB3, and the UEAssistancelnfo may be sent on SRB1 or SRB3, and the UElnformationResponse may be sent on SRB1 or SRB2. In another example, if the UE 10 receives session start indication, the UE 10 may route the session start indication on a first radio bearer, e.g., SRB1, or SRB3, while QoE measurements for the application layer are rerouted via SRB4. Upon receiving a session start indication over SRB1/SRB3, the radio network node may configure/reconfigure SRB4 resources for the UE 10. In some other embodiments if the UE 10 receives session end indication, the UE 10 may route the session start indication on the first radio bearer, e.g., SRB1, or SRB), while QoE measurements for application layer are rerouted via SRB4.

In some embodiments, the routing of a QoE report is not determined based on the report type, but based on some other distinguisher, e.g.:
QoE Reference, which uniquely identifies a QoE/RVQoE measurement configuration.
Service type that the report pertains to.
Any other parameter from the corresponding QoE/RVQoE configuration.

Action 404. The UE 10 may transmit the message to a lower layer. For example, the UE 10 may transmit the indication to the lower layers based on the selected message type and the bearer type.

In some related embodiments, the radio network node configures the UE 10 with the instructions how to perform the above handling. In some other embodiments, the decision is up to the UE 10.

As stated above the UE 10 may send different types of QoE measurements in different messages, e.g. QoE measurements for application layer in MeasReportAppLayer while QoE measurements for RAN in the MeasurementReport message, or UEAssistanceInfo message, or UEInformationResponse message. In this section it is on the other hand described embodiments when the UE 10 uses the same message type to send different type of QoE measurements but on different radio bearers. Thus, it is herein described routing of a particular message depending on content.

The UE 10 may send a message on a first radio bearer if there is a first content of the message and send on a second radio bearer if there is a second content of the message. For example, the UE 10 may send an instance of the message MeasReportAppLayer on SRB4 if the message contains QoE measurements for application layer but may send an instance of the message MeasReportAppLayer on SRB1 if the message contains QoE measurements for RAN.

This embodiment has the benefit that different contents may have different urgency. The QoE measurements for application layer may not be as time critical compared to QoE measurements for RAN. SRB4 may in general have lower priority than SRB1 or SRB2 and hence, by routing the message on SRB4 if the content is QoE measurements for application layer, while routing the message on SRB1 if the content is QoE measurements for RAN, the measurements may get an appropriate priority. This may ensure that when the UE 10 performs a transmission, low priority QoE measurements for application layer will not be prioritized over potential other higher priority data. While at the same time, high priority QoE measurements for RAN may be prioritized over potential other lower priority data.

In a related embodiment, the selection of bearer type to carry a certain type of QoE report is determined on the UE Application layer, while in another related embodiment it is executed at the UE Access Stratum (UE AS) layer.

The UE 10 may select or choose the message type and/or the bearer type to send the indication based on criticality. The criticality of one report over the other may be determined based on the report type, e.g., RVQoE reports are more urgent than regular QoE reports. In other embodiments, the criticality of a report can be so that certain instances of report within one report type are more critical than some other instances of reports of the same report type, where the criticality decides the message type, SRB on which the report is sent etc. For example, the RVQoE reports carrying measurement results that indicate poor QoE are of highest criticality.

In some embodiments, the criticality of a report, which in turn may determine the report handling, follows from the report type (regular vs RVQoE report), while in some other embodiments, the criticality is determined by the QoE Reference, or some other parameter from the QoE/RVQoE configuration, e.g., Single—Network Slice Selection Assistance Information (S-NSSAI) list, Area Scope etc.

In some embodiments, the criticality of a certain report, which in turn may determine the report handling, can be explicitly indicated from the UE Application to the UE AS, while in some other embodiments the UE AS determines the criticality.

In some related embodiments, the radio network node configures the UE 10 with the instructions how to perform the above handling. In some other embodiments, the decision is up to the UE 10.

In one embodiment, if actions in the UE 10 suggests that the UE 10 is to send two different contents of a message, the UE 10 may refrain from sending one instance of the message with both contents. Instead, the UE 10 may send a first instance of the message with the first content and a second instance of the message with the second content. Thus, avoiding mixed content in one message instance.

For example, the UE 10 may be in a situation where it should transmit both QoE measurements for application layer and QoE measurements for RAN. A typical scenario where a regular QoE report and a RVQoE report may be simultaneously ready for transmission may be when periodic regular QoE reporting is configured, so that intermediate regular QoE reports are sent for an ongoing application session, and RVQoE reports are also sent for the same application session, where possibly the data in the RVQoE report(s) is derived from the data in the regular QoE report(s). The UE 10 may in this scenario determine that the two types of QoE measurements are to be sent in two separate instances of a message.

For example, if it is so that QoE measurements for application layer and QoE measurements for RAN are both to be sent in the MeasReportAppLayer message. Which implies that the MeasReportAppLayer message is defined so that it can carry both types of QoE measurements. The UE 10 may according to this embodiment send a first instance of this message containing QoE measurements for application layer and send a second instance of this message containing QoE measurements for RAN.

This embodiment has the benefit that the UE 10 may send the first and the second message on different radio bearers, which would not be possible if the UE 10 would put both types of QoE measurements in the same instance of the message.

In a related sub-embodiment, the “UE” may be the UE Application Layer, while in another related sub-embodiment the “UE” may be the UE Access Stratum.

In some related embodiments, the radio network node configures the UE 10 with the instructions how to perform the above handling. In some other embodiments, the decision is up to the UE 10.

Thus, it is herein disclosed embodiments wherein regular QoE reports and RVQoE reports are handled in the same message.

The UE 10 may choose to send one or more regular QoE report(s) and one or more RVQoE report(s) in the same message, at least if the regular QoE report(s) and the RVQoE report(s) contain data pertaining to a same application session. As above, a typical scenario where a regular QoE report and a RVQoE report may be simultaneously ready for transmission may be when periodic regular QoE reporting is configured, so that intermediate regular QoE reports are sent for an ongoing application session, and RVQoE reports are also sent for the same application session, where possibly the data in the RVQoE report(s) is derived from the data in the regular QoE report(s). The UE 10 may then choose to send the regular QoE report(s) and the RVQoE report(s) separate messages (of the same or different types), as described above, or send the regular QoE report(s) and the RVQoE report(s) in the same message, e.g. a MeasReportAppLayer message.

If the UE 10 sends the regular QoE report(s) and the RVQoE report(s) in the same message, the UE 10 may be mandated to transmit the message on SRB4.

If the UE 10 sends the regular QoE report(s) and the RVQoE report(s) in the same message, the UE 10 may be allowed to let the highest priority (most delay sensitive) data in the message, e.g., the RVQoE report(s), govern which SRB the message is sent on. This may result in that the UE 10 transmits the message on SRB1. In another embodiment, the UE 10 may choose any of SRB1, SRB2, SRB3 and SRB4 for transmission of the message including both regular QoE report(s) and RVQoE report(s).

The radio network node may configure, e.g. in the system information, how the UE 10 is to transmit messages containing both regular QoE report(s) and RVQoE report(s), e.g. if the UE 10 should transmit such messages on SRB4 or on SRB1 or if the UE 10 may choose the SRB (e.g. SRB1, SRB2, SRB3 or SRB4) to transmit such messages on.

Alternatively or additionally, information in, or together with, the QoE configuration and/or in, or together with, the RVQoE configuration indicates to the UE 10 which SRB to use for transmission of messages containing both regular QoE report(s) and RVQoE report(s), e.g. if the UE 10 should transmit such messages on SRB4 or on SRB1 or if the UE 10 may choose the SRB (e.g. SRB1, SRB2, SRB3 or SRB4) to transmit such messages on.

In other embodiments, the radio network node indicates, e.g., via the system information, whether a UE should send regular QoE reports and RVQoE reports in separate messages, or is allowed to send regular QoE reports and RVQoE reports in the same message.

In other embodiments, information in, or together with, the QoE configuration and/or in, or together with, the RVQoE configuration indicates to a UE whether the UE should send regular QoE reports and RVQoE reports in separate messages, or is allowed to send regular QoE reports and RVQoE reports in the same message.

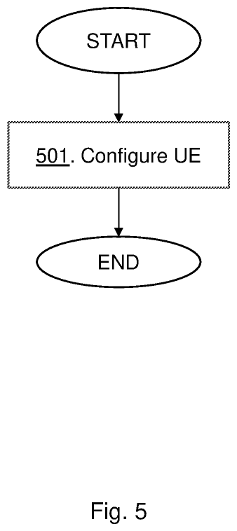

The method actions performed by the radio network node such as the first or the second radio network node 13, for handling communication in the wireless communications network 1 according to embodiments herein will now be described with reference to a flowchart depicted in FIG. 5. The actions do not have to be taken in the order stated below, but may be taken in any suitable order. Actions performed in some embodiments are marked with dashed boxes.

Action 501. The radio network node configures to the UE 10 to process or apply one or more indications relating to the QoE process in one or more messages, also referred to as report handling, for one or more bearers, wherein applying the indication comprises selecting a message type and/or a bearer type to send the indication to the radio network node depending on a type of a QoE measurement and/or a criticality of the QoE measurement of the indication. The indication is relating to the QoE process or measurement. The indication may comprise one or more of the following: a regular QoE measurement, a RAN visible QoE measurement, a Session Start Indication, and a Session End Indication.

The radio network node may indicate, e.g., via the system information, whether a UE should send regular QoE reports and RVQoE reports in separate messages, or is allowed to send regular QoE reports and RVQoE reports in the same message.

The radio network node may reconfigure one or more bearers for the QoE measurements for application layer and/or for the QoE measurements for RAN.

The radio network node such as the first radio network node 12 may configure the UE 10 or a group of UEs for QoE measurements for application layer and QoE measurements for RAN in the same RRC message (RRC Reconfiguration message), i.e. using a common (signalling) radio bearer, e.g. SRB1, and may configure the UE Access Stratum to use a first (signalling) radio bearer, e.g. SRB1 or SRB3, for sending QoE measurements for RAN and a second (signaling) radio bearer, e.g. SRB4, for sending QoE measurements for application layer.

The radio network node may configure the UE 10 or a group of UEs for QoE measurements for application layer and QoE measurements for RAN in different (subsequent) messages, e.g., QoE measurements for application layer in a first RRC message and QoE measurements for RAN in a subsequent RRC message.

In one embodiment, the radio network node may obtain or derive different (signaling) radio bearer to use for at least one of QoE measurements for application layer or QoE measurements for RAN based on one or more of the following:
indications or configuration parameters, e.g., service type or service subtype, or policies received from another network node, e.g. a second RAN node, the second radio network node 13, a CN node, an operation, administration and maintenance (OAM) node, an service management & orchestrator (SMO) node.
   For example, the radio network node may derive that SRB4 is to be used for certain service types that do not required expedited QoE reporting for both QoE measurements for application layer and QoE measurements for RAN (e.g. MTSI or streaming) and, instead, it derives that SRB1 is to be used for QoE measurements for RAN for service type equals to VR or URLCC

The radio network node may reconfigure (signaling) radio bearer(s) for QoE measurements for application layer and/or for QoE measurements for RAN depending on the RRC state of the UE 10 or the RRC procedure being executed. For example, different (signaling) radio bearer(s) may be selected for sending QoE measurements for application layer and/or for sending QoE measurements for RAN in case of Re-establishment, RRC Resume, RRC Setup or in case of mobility (Reconfiguration with Synch).

In one embodiment the UE 10 may mirror RAN node embodiments for example by applying the configuration.

Handling of QoE measurements in mobility.

In one embodiment, upon mobility from the first radio network node 12 to the second radio network node 13, and wherein the second radio network node 13 does not support the same combination of (signalling) radio bearers used by the first radio network node 12 (prior to mobility) to carry at least one of the QoE measurements for application layer or the QoE measurement for RAN, the second radio network node 13 may reconfigure at least one (signaling) radio bearer(s) to be used for carrying at least one or both of QoE measurements for application layer and QoE measurement for RAN. Various options are possible, e.g.:
the second radio network node 13 supports (signaling) radio bearer used by the first radio network node 12 to carry the QoE measurement for RAN (e.g. SRB1 or SRB2), but does not support (signaling) radio bearer used by the first radio network node 12 to carry the QoE measurement for application layer (e.g. SRB4).
the second radio network node 13 does not support (signaling) radio bearer used by the first radio network node 12 to carry the QoE measurement for RAN (e.g. SRB3), but does support (signaling) radio bearer used by the first radio network node 12 to carry the QoE measurement for application layer (e.g. SRB4)

In one embodiment, upon mobility from the first radio network node 12 to the second radio network node 13, and wherein the second radio network node 13 does not support the same combination of (signalling) radio bearers used by the first radio network node 12 (prior to mobility) to carry the QoE measurements for application layer and the QoE measurement for RAN, the second radio network node 13 may, upon mobility, release (explicitly or implicitly), or does not configures the same type of (signaling) radio bearer(s) used by the first radio network node 12 to carry at least one of the QoE measurements for application layer or the QoE measurement for RAN. For example, in a case where the first radio network node 12 supports SBR3 and SRB4, while the target RAN node supports SRB4 but does not support SRB3, the second radio network node 13 may release (explicitly or implicitly) SRB3 and use configure SRB4 to be used for reporting of both QoE measurements for application layer and QoE measurement for RAN.
the release of a (signaling) radio bearer used by the first radio network node 12 to carry QoE measurements for application layer can have the further consequence of releasing of QoE measurements for RAN, or
the release of a (signaling) radio bearer used by the first radio network node 12 to carry QoE measurements for RAN can have the further consequence of releasing of QoE measurements for application layer, or

In one embodiment the UE 10 mirrors RAN node embodiments for example by applying the configuration.

### (Re) Configuring Bearers in Case of Addition or Removal of QoE Configuration

In one embodiment, the first radio network node 12 may (re)configure for the UE 10, at least one of the (signalling) radio bearer(s) used to carry QoE measurements for application layer or QoE measurements for RAN, when a new QoE configuration is sent to the UE 10 (e.g. for an additional service type). An example of this situation can arise when UE 10 is first configured for QoE measurements for a first service type for which only QoE measurements for application layer are desirable, and later on the same UE 10 is configured for QoE measurement for a second service type for which both QoE measurements for application layer and QoE measurements for RAN are desirable. The opposite case can happen. For example, if the UE 10 is configured for QoE measurements for application layer and for QoE measurements for RAN for two or more service types (or service subtypes) and one of the service type is no longer used (or the corresponding QoE configuration is removed/terminated) the first radio network node 12 may (re)configure the (signalling) radio bearer(s) to be used to carry QoE measurements for the remaining service types (or service subtypes).

In one embodiment the UE 10 may mirror RAN node embodiments for example by applying the configuration.

### (Re) Configuring Bearers in Case of Overload

In one embodiment, the first radio network node 12 may reconfigure at least one of the (signalling) radio bearer(s) used to carry QoE measurements for application layer or QoE measurements for RAN, e.g. to alleviate the interference over the radio interface. For example, if QoE measurements for RAN are reported over SRB1 in a non-overload situation, the first radio network node 12, upon detection of an overload situation (e.g. over the radio interface), may reconfigure the (signaling) bearer to be used to carry QoE measurements for RAN to SRB4. This may provide more opportunity to use SRB1 bearer for more critical services, e.g., voice calls. When overload is solved, the first radio network node 12 may reconfigure the (signaling) radio bearer to be used for reporting QoE measurements for RAN from SRB4 to SRB1.

In one embodiment the UE 10 may mirror RAN node embodiments for example by applying the configuration.

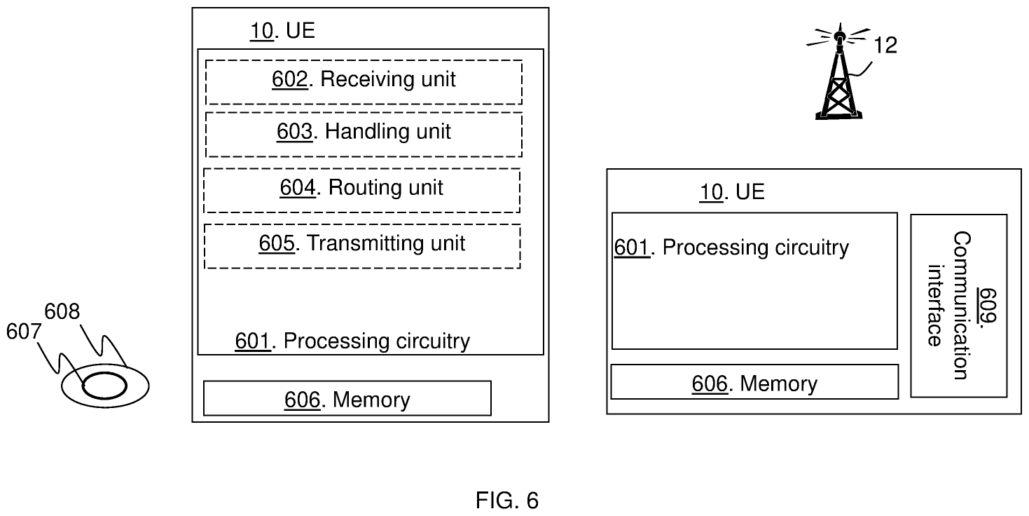

FIG. 6 is a block diagram depicting the UE 10 for handling communication in the wireless communications network 1 according to embodiments herein.

The UE 10 may comprise processing circuitry 601, e.g. one or more processors, configured to perform the methods herein. The UE 10 may comprise a receiving unit 602, e.g. a receiver or a transceiver. The UE 10, the processing circuitry 601 and/or the receiving unit 602 is configured to receive from the upper layer the indication relating to the QoE process. The indication may comprise one or more of the following: the regular QoE measurement, the RAN visible QoE measurement, the Session Start Indication, and the Session End Indication. Thus, the UE 10, the processing circuitry 601 and/or the receiving unit 602 may be configured to receive the indication from the upper layer (e.g., application layer), the indication may be at least
QoE measurements for application layer, or
QoE measurements for RAN, or
Session Start Indication, or
Session Stop/End indication.

The UE 10 may comprise a handling unit 603, e.g., a message handler or a bearer handler. The UE 10, the processing circuitry 601 and/or the handling unit 603 is configured to process or apply the indication in one or more messages, and/or on one or more bearers, wherein the UE 10, the processing circuitry 601 and/or the handling unit 603 is configured to apply the indication by selecting a message type and/or a bearer type to send the indication to the radio network node depending on a type of a QoE measurement and/or a criticality of the QoE measurement of the indication. The UE 10, the processing circuitry 601 and/or the handling unit 603 may be configured to apply different QoE measurement types in different messages or a same message. The UE 10, the processing circuitry 601 and/or the handling unit 603 may be configured to select or choose a message type and/or a bearer type to send the indication to the radio network node such as the first radio network node 12 or the second radio network node 13. The UE 10, the processing circuitry 601 and/or the handling unit 603 may be configured to select or choose the message type and/or the bearer type to send the indication based on criticality. The UE 10, the processing circuitry 601 and/or the handling unit 603 may be configured to apply a first instance of the message with the first content and a second instance of the message with the second content. Thus, avoiding mixed content in one message instance.

The UE 10 may comprise a routing unit 604. The UE 10, the processing circuitry 601 and/or the routing unit 604 may be configured to route the indication to the radio network node based on the selected message type and/or selected bearer type. The UE 10, the processing circuitry 601 and/or the routing unit 604 may be configured to route the first message on the first bearer, and the second message on the second bearer.

The UE 10 may comprise a transmitting unit 605, e.g. a receiver or a transceiver. The UE 10, the processing circuitry 601 and/or the transmitting unit 605 may be configured to transmit the message to a lower layer. For example, the UE 10, the processing circuitry 601 and/or the transmitting unit 605 may be configured to transmit the indication to the lower layers based on the selected message type and the bearer type. The radio network node may indicate, e.g., via the system information, whether a UE should send regular QoE reports and RVQoE reports in separate messages, or is allowed to send regular QoE reports and RVQoE reports in the same message.

The UE may comprise a memory 606. The memory 606 comprises one or more units to be used to store data on, such as data packets, indications, report handling instructions, bearer information, message type information, one or more conditions, mobility events, measurements, events and applications to perform the methods disclosed herein when being executed, and similar. Furthermore, the UE may comprise a communication interface 609 such as comprising a transmitter, a receiver, a transceiver and/or one or more antennas.

The methods according to the embodiments described herein for the UE 10 are respectively implemented by means of e.g. a computer program product 607 or a computer program, comprising instructions, i.e., software code portions, which, when executed on at least one processor, cause the at least one processor to carry out the actions described herein, as performed by the UE 10. The computer program product 607 may be stored on a computer-readable storage medium 608, e.g. a disc, a universal serial bus (USB) stick or similar. The computer-readable storage medium 608, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a wireless communications network, wherein the UE 10 comprises processing circuitry and a memory, said memory comprising instructions executable by said processing circuitry whereby said UE 10 is operative to perform any of the methods herein.

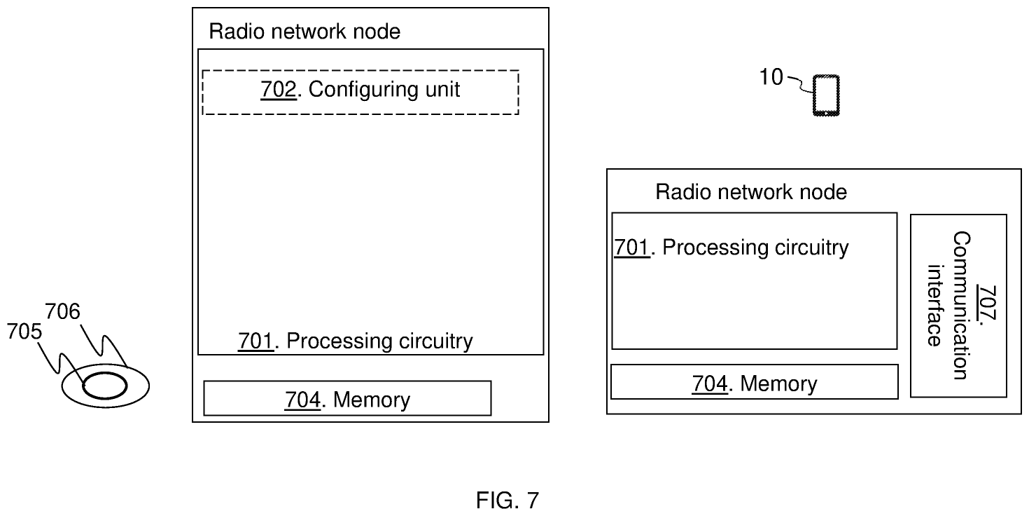

FIG. 7 is a block diagram depicting the radio network node, such as the first radio network node 12 or the second radio network node 13 for handling communication in the wireless communications network 1 according to embodiments herein.

The radio network node may comprise processing circuitry 701, e.g. one or more processors, configured to perform the methods herein.

The radio network node may comprise a configuring unit 702, e.g. a transmitter or a transceiver. The radio network node, the processing circuitry 701 and/or the configuring unit 702 is configured to configure the UE 10 with a configuration or a policy regarding handling indications relating to measurements of QoE. The radio network node, the processing circuitry 701 and/or the configuring unit 702 is configured to configure the UE 10 to process or apply one or more indications relating to the QoE process in one or more messages, also referred to as report handling, and/or for one or more bearers, wherein applying the indication comprises selecting the message type and/or the bearer type to send the indication to the radio network node depending on the type of a QoE measurement and/or the criticality of the QoE measurement of the indication. The indication is relating to the QoE process. The indication may comprise one or more of the following: the regular QoE measurement, the RAN visible QoE measurement, the Session Start Indication, and the Session End Indication.

The radio network node, the processing circuitry 701 and/or the configuring unit 702 may be configured to indicate, e.g., via the system information, whether the UE 10 should send regular QoE reports and RVQoE reports in separate messages, or is allowed to send regular QoE reports and RVQoE reports in the same message.

The radio network node, the processing circuitry 701 and/or the configuring unit 702 may be configured to reconfigure the one or more bearers for the QoE measurements for application layer and/or for the QoE measurements for RAN.

The radio network node, the processing circuitry 701 and/or the configuring unit 702 may be configured to configure the UE 10 or the group of UEs for QoE measurements for application layer and QoE measurements for RAN in the same RRC message (RRC Reconfiguration message), i.e. using the common (signalling) radio bearer, e.g. SRB1, and may configure the UE Access Stratum to use the first (signalling) radio bearer, e.g. SRB1 or SRB3, for sending QoE measurements for RAN and the second (signaling) radio bearer, e.g. SRB4, for sending QoE measurements for application layer.

The radio network node, the processing circuitry 701 and/or the configuring unit 702 may be configured to configure the UE 10 or the group of UEs for QoE measurements for application layer and QoE measurements for RAN in different (subsequent) messages, e.g., QoE measurements for application layer in a first RRC message and QoE measurements for RAN in the subsequent RRC message.

The radio network node, the processing circuitry 701 and/or the configuring unit 702 may be configured to obtain or derive different (signaling) radio bearer to use for at least one of QoE measurements for application layer or QoE measurements for RAN based on one or more of the following:
indications or configuration parameters, e.g., service type or service subtype, or policies received from another network node, e.g. a second RAN node, the second radio network node 13, a CN node, an operation, administration and maintenance (OAM) node, an service management & orchestrator (SMO) node.
   For example, the radio network node derives that SRB4 is to be used for certain service types that do not required expedited QoE reporting for both QoE measurements for application layer and QoE measurements for RAN (e.g. MTSI or streaming) and, instead, it derives that SRB1 is to be used for QoE measurements for RAN for service type equals to VR or URLCC

The radio network node, the processing circuitry 701 and/or the configuring unit 702 may be configured to reconfigure (signaling) radio bearer(s) for QoE measurements for application layer and/or for QoE measurements for RAN depending on the RRC state of the UE 10 or the RRC procedure being executed. For example, different (signaling) radio bearer(s) can be selected for sending QoE measurements for application layer and/or for sending QoE measurements for RAN in case of Re-establishment, RRC Resume, RRC Setup or in case of mobility (Reconfiguration with Synch).

In one embodiment, upon mobility from the first radio network node 12 to the second radio network node 13, and wherein the second radio network node 13 does not support the same combination of (signalling) radio bearers used by the first radio network node 12 (prior to mobility) to carry at least one of the QoE measurements for application layer or the QoE measurement for RAN, the second radio network node 13 may be configured to reconfigure at least one (signaling) radio bearer(s) to be used for carrying at least one or both of QoE measurements for application layer and QoE measurement for RAN. Various options are possible, e.g.:
the second radio network node 13 supports (signaling) radio bearer used by the first radio network node 12 to carry the QoE measurement for RAN (e.g. SRB1 or SRB2), but does not support (signaling) radio bearer used by the first radio network node 12 to carry the QoE measurement for application layer (e.g. SRB4).
the second radio network node 13 does not support (signaling) radio bearer used by the first radio network node 12 to carry the QoE measurement for RAN (e.g. SRB3), but does support (signaling) radio bearer used by the first radio network node 12 to carry the QoE measurement for application layer (e.g. SRB4) The radio network node, the processing circuitry 701 and/or the configuring unit 702 may be configured to (re)configure for the UE 10, at least one of the (signalling) radio bearer(s) used to carry QoE measurements for application layer or QoE measurements for RAN, when a new QoE configuration is sent to the UE 10 (e.g. for an additional service type).

The radio network node, the processing circuitry 701 and/or the configuring unit 702 may be configured to reconfigure at least one of the (signalling) radio bearer(s) used to carry QoE measurements for application layer or QoE measurements for RAN, e.g. to alleviate the interference over the radio interface. This may provide more opportunity to use SRB1 bearer for more critical services, e.g., voice calls. When overload is solved, the first radio network node 12 may reconfigure the (signaling) radio bearer to be used for reporting QoE measurements for RAN from SRB4 to SRB1.

The radio network node may comprise a memory 704. The memory 704 comprises one or more units to be used to store data on, such as data packets, indications, report handling instructions, bearer information, message type information, one or more conditions, events and applications to perform the methods disclosed herein when being executed, and similar. Furthermore, the radio network node may comprise a communication interface 707 such as comprising a transmitter, a receiver, a transceiver and/or one or more antennas.

The methods according to the embodiments described herein for the radio network node are respectively implemented by means of e.g. a computer program product 705 or a computer program, comprising instructions, i.e., software code portions, which, when executed on at least one processor, cause the at least one processor to carry out the actions described herein, as performed by the radio network node. The computer program product 705 may be stored on a computer-readable storage medium 706, e.g. a disc, a universal serial bus (USB) stick or similar. The computer-readable storage medium 706, having stored thereon the computer program product, may comprise the instructions which, when executed on at least one processor, cause the at least one processor to carry out the actions described herein, as performed by the radio network node. In some embodiments, the computer-readable storage medium may be a transitory or a non-transitory computer-readable storage medium. Thus, embodiments herein may disclose a radio network node for handling communication in a wireless communications network, wherein the radio network node comprises processing circuitry and a memory, said memory comprising instructions executable by said processing circuitry whereby said radio network node is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Embodiment 1. A method performed by a UE for handling communication in a wireless communications network. The method comprising
receiving from the upper layer one or more indications relating to a quality of experience, QoE, process; and
processing or applying the indication in one or more messages, and/or on one or more bearers.

Embodiment 2: The method according to embodiment 1, wherein processing comprises applying different QoE measurement types in different messages or a same message.

Embodiment 3: The method according to any of the embodiments 1-2, wherein processing comprises selecting a message type and/or a bearer type to send the indication to a radio network node.

Embodiment 4: The method according to any of the embodiments 1-3, wherein processing comprises applying a first instance of the message with a first content and a 15 second instance of the message with a second content.

Embodiment 5: The method according to any of the embodiments 1-4, wherein the indication comprises one or more of the following: QoE measurement for application layer, QoE measurement for RAN, Session Start Indication, and Session End Indication.

Embodiment 6: The method according to any of the embodiments 1-5, further comprising routing the indication to the radio network node based on the selected message type and/or selected bearer type.

Embodiment 7: The method according to any of the embodiments 1-6, further comprising transmitting the message to a lower layer.

Embodiment 8. A method performed by a radio network node for handling communication in a wireless communications network. The method comprising
configuring a UE with a configuration to process or apply one or more indications relating to a quality of experience, QoE, process in one or more messages, and/or for one or more bearers.

Embodiment 9: The method according to embodiment 8, wherein the one or more indications comprise one or more of the following: QoE measurement for application layer, QoE measurement for RAN, Session Start Indication, and Session End Indication.

Embodiment 10: The method according to any of the embodiments 8-9, wherein the configuration indicates whether the UE should send regular QoE reports and RVQoE reports in separate messages, or is allowed to send regular QoE reports and RVQoE reports in the same message.

Embodiment 11. A UE for handling communication in a wireless communications network. The UE is configured to
receive from the upper layer one or more indications relating to a quality of experience process; and
process or apply the indication in one or more messages, and/or on one or more bearers.

Embodiment 12. A radio network node for handling communication in a wireless communications network. The radio network node is configured to
configure a UE with a configuration to process or apply one or more indications relating to a quality of experience process in one or more messages and/or for one or more bearers.

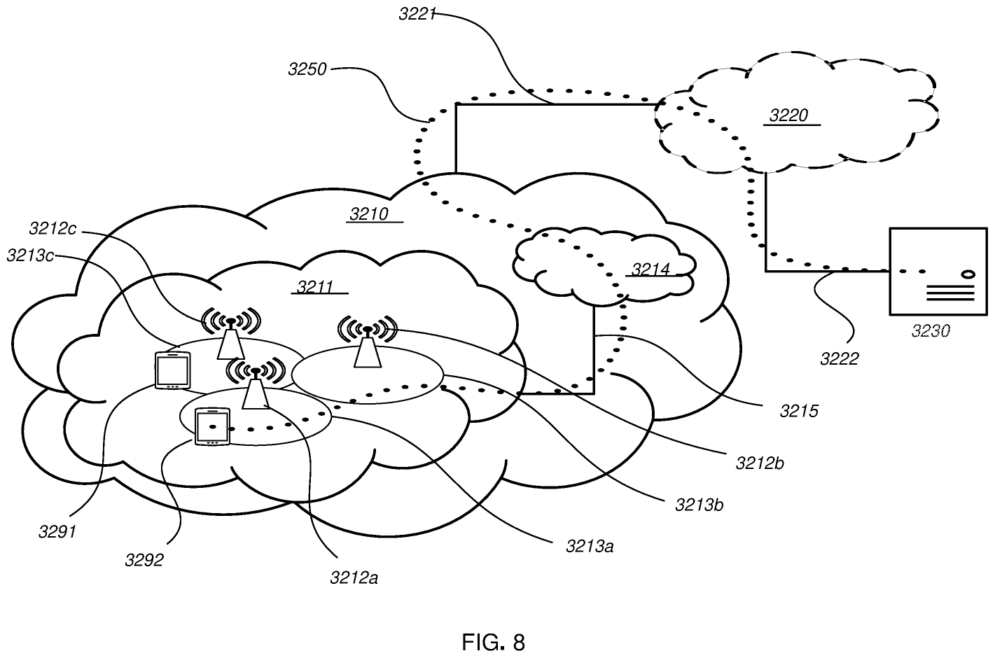

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12, 13 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

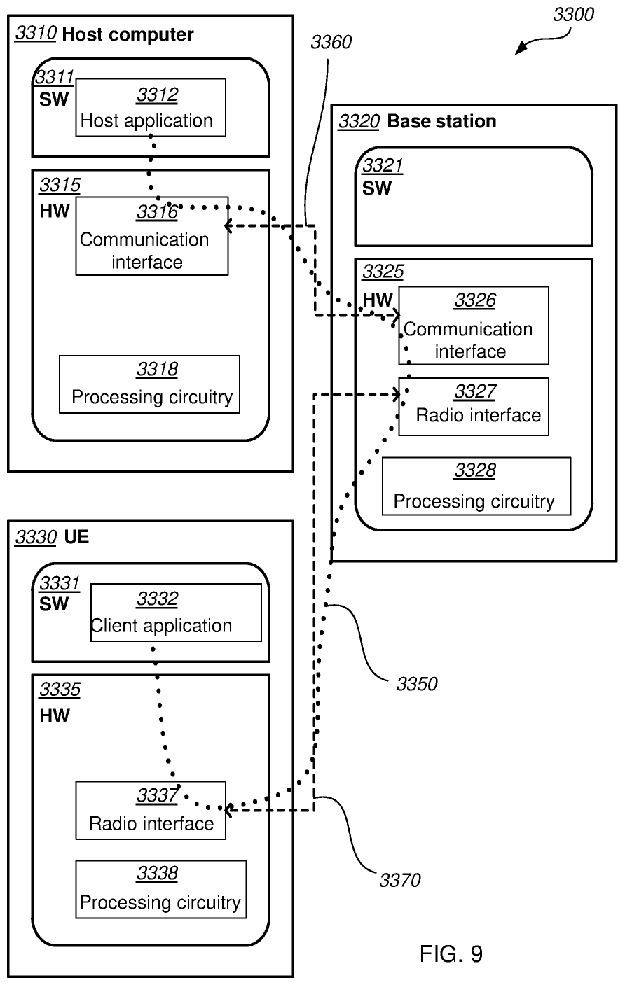

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since the process of handling measurements of QoE is handled more efficiently to a correct level in the network, and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

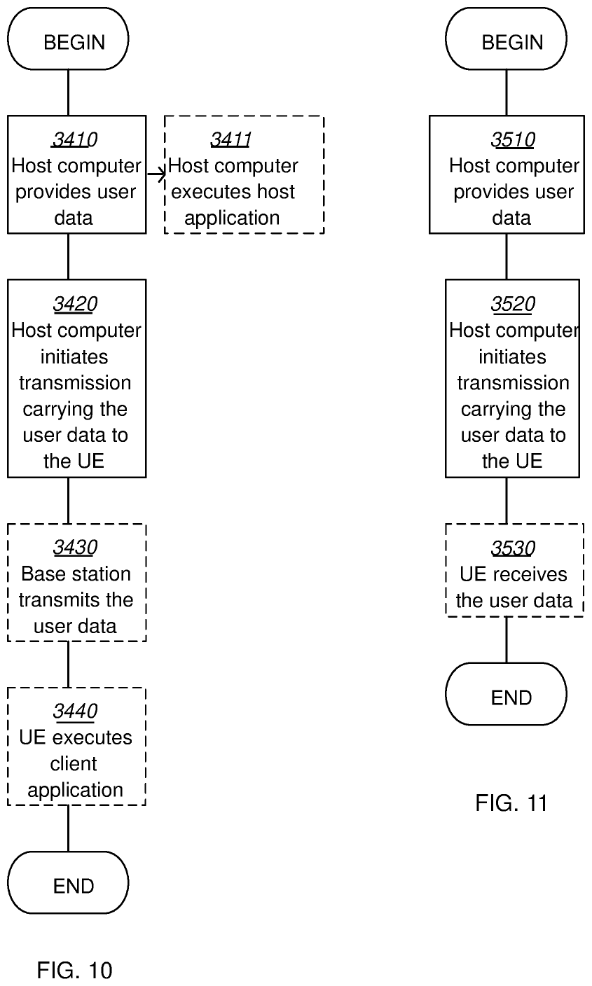

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

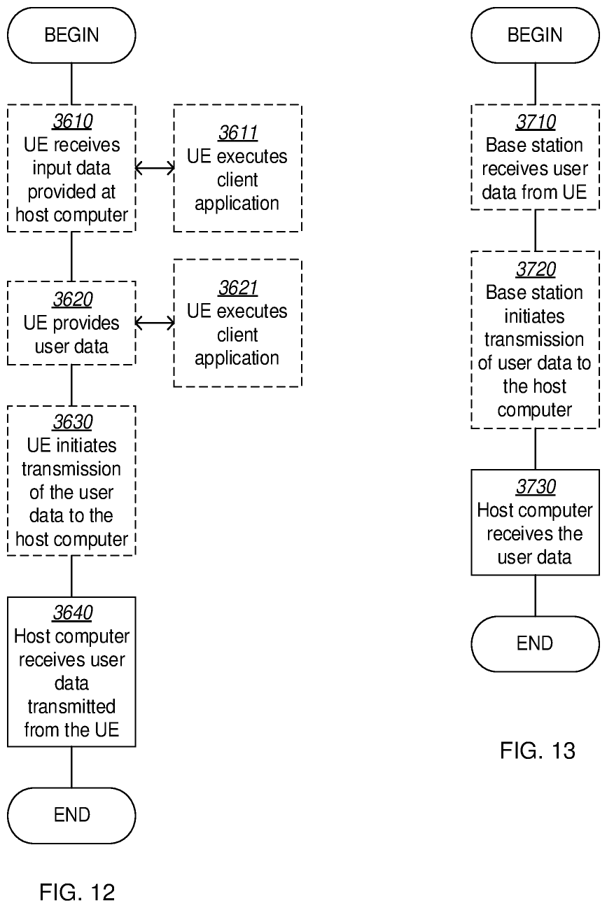

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviation Explanation

UE User Equipment (Wireless device in 3GPP systems)
NR New Radio
LTE Long Term Evolution
gNB Base station in NR
eNB Base station in LTE
RRC Radio Resource Control
PDCP Packet Data Convergence Protocol
RLC Radio Link Control
MAC Medium Access Control
RAN Radio Access Network
QoE Quality of Experience
SRB Signalling Radio Bearer
UMTS Universal Mobile Terrestrial System
IMS IP Multimedia Subsystem
MTSI Mobility Telephony Service for IMS
O&M Operation and Maintenance
CN Core Network
TCE Trace Collector Entity
AR Augmented Reality
VR Virtual Reality
URLLC Ultra-Reliable Low-Latency Communication
UTRAN Universal Terrestrial Radio Access Network
E-UTRAN Evolved-UTRAN
IE Information Element
CR Change Request
TS Technical Specification
3GPP 3rd generation partnership project
QMC QoE Measurement Collection
CGI Cell Global Identity
RAI Routing Area Identifier
LAI Location Area Identifier
TAC Tracking Area Code
RVQoE RAN Visible QoE
AS Access Stratum
NAS Non-Access Stratum
S-NSSAI Single Network-Network Slice Selection Assistance Information

1-26. (canceled)

27. A method performed by a user equipment (UE) for handling communication in a wireless communications network, the method comprising:
receiving from an upper layer an indication relating to a quality of experience (QoE) process; and
applying the indication in one or more messages and/or for one or more bearers, wherein applying the indication comprises selecting a message type and/or a bearer type to send the indication to a radio network node depending on a type of a QoE measurement and/or a criticality of the QoE measurement of the indication.

28. The method according to claim 27, wherein the indication comprises one or more of:
a regular QoE measurement;
a radio access network (RAN) Visible (RV) QoE measurement;
a Session Start Indication; and
a Session End Indication.

29. The method according to claim 27, wherein applying the indication comprises applying different QoE measurement types in different messages, or in a same message.

30. The method according to claim 27, wherein selecting the message type to carry a certain type of QoE report is determined on a UE Application layer, or at the UE Access Stratum (AS) layer.

31. The method according to claim 27, further comprising routing the indication to the radio network node based on:
the selected message type;
the selected bearer type;
a QoE reference uniquely identifying a QoE and/or a RAN Visible QoE (RVQoE) measurement configuration;
a Service type that the indication pertains to; and/or
any parameter from a corresponding QoE and/or RVQoE configuration.

32. The method according to claim 31, wherein routing the indication comprises routing a first message on a first bearer, and a second message on a second bearer.

33. The method according to claim 27, further comprising transmitting the message to a lower layer based on the selected message type and/or the selected bearer type.

34. The method according to claim 27, wherein applying the indication comprises applying a first content in a first instance of the message and a second content in a second instance of the message.

35. The method according to claim 27, wherein applying the indication comprises sending a QoE measurement for application layer in a MeasurementReportAppLayer message, and sending a QoE measurement for a RAN in another message, wherein the another message comprises one of:
a MeasurementReport message;
a UEAssistancelnfo message;
a UElnformationResponse message; and
a message defined for the purpose of sending QoE measurements for RAN.

36. A method performed by a radio network node for handling communication in a wireless communications network, the method comprising:
configuring a user equipment (UE) with a configuration to apply an indication relating to a quality of experience (QoE) process in one or more messages, and/or for one or more bearers; and
wherein applying the indication comprises selecting a message type and/or a bearer type to send the indication to a radio network node depending on a type of a QoE measurement and/or a criticality of the QoE measurement of the indication.

37. The method according to claim 36, wherein the one or more indications comprise one or more of:
a regular QoE measurement;
a radio access network (RAN) Visible (RV) QoE measurement;
a Session Start Indication; and
a Session End Indication.

38. The method according to claim 36, wherein the configuration indicates whether the UE should send regular QoE reports and RAN Visible QoE (RVQoE) reports in separate messages or is allowed to send regular QoE reports and RVQoE reports in the same message.

39. A user equipment (UE) for handling communication in a wireless communications network, wherein the UE is configured to:
receive, from an upper layer, an indication related to a quality of experience (QoE) process; and
apply the indication in one or more messages and/or for one or more bearers, wherein the UE is configured to apply the indication by selecting a message type and/or a bearer type to send the indication to a radio network node depending on a type of a QoE measurement and/or a criticality of the QoE measurement of the indication.

40. The UE according to claim 39, wherein the indication comprises one or more of:
a regular QoE measurement;
a radio access network (RAN) Visible (RV) QoE measurement;
a Session Start Indication; and
a Session End Indication.

41. The UE according to claim 39, wherein the UE is configured to apply the indication by applying different QoE measurement types in different messages or in a same message.

42. The UE according to claim 39, wherein the UE is configured to select the message type to carry a certain type of QoE report by determining on a UE Application layer, or at the UE Access Stratum (AS) layer.

43. The UE according to claim 39, wherein the UE is further configured to route the indication to the radio network node based on:
the selected message type;
the selected bearer type;
a QoE Reference uniquely identifying a QoE/RVQoE measurement configuration;
a Service type that the indication pertains to; and/or
any other parameter from a corresponding QoE/RVQoE configuration.

44. The UE according to claim 43, wherein route the indication comprises routing a first message on a first bearer, and a second message on a second bearer.

45. The UE according to claim 27, wherein the UE is further configured to transmit the message to a lower layer based on the selected message type and/or the selected bearer type.

46. The UE according to claim 27, wherein the UE is configured to apply the indication by applying a first content in a first instance of the message and a second content in a second instance of the message.

47. The UE according to claim 27, wherein the UE is configured to apply the indication by:
sending a QoE measurement for the application layer in a MeasReportAppLayer message; and
sending a QoE measurement for the RAN in another message comprising one of:
a MeasurementReport message;
a UEAssistancelnfo message;
a UElnformationResponse message; and
a message defined for the purpose of sending QoE measurements for RAN.

48. A radio network node for handling communication in a wireless communications network, the radio network node being configured to:
configure a user equipment (UE) with a configuration to apply an indication relating to a quality of experience (QoE) process in one or more messages, and/or for one or more bearers; and
wherein applying the indication comprises selecting a message type and/or a bearer type to send the indication to a radio network node depending on a type of a QoE measurement and/or a criticality of the QoE measurement of the indication.
